(19) United States
(12) Patent Application Publication
(10) Pub. No.: US 2008/0056629 A1
(43) Pub. Date: Mar. 6, 2008

(54) FLUID DYNAMIC PRESSURE EMPLOYING BEARING, SPINDLE MOTOR, AND STORAGE DISK DRIVE

(75) Inventors: Keisaku NAKANO, Minami-ku (JP); Tomokazu HASEGAWA, Minami-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Minami-ku, Kyoto (JP)

(21) Appl. No.: 11/850,403

(22) Filed: Sep. 5, 2007

(30) Foreign Application Priority Data
Sep. 6, 2006 (JP) 2006-241249

(51) Int. Cl. F16C 33/10; G11B 5/60

(52) U.S. Cl. 384/100; 360/224

(57) ABSTRACT

At least one of a shaft and a bearing of a fluid dynamic bearing unit includes an additive-providing portion including the additive on a surface thereof. The lubricating oil is retained between the shaft and the bearing, and contacts the surface of the additive-providing portion. The additive-providing portion is for example a joining member such as adhesive, a housing made of resin, a sleeve made of porous material, an oil repellent coating made of oil repellent agent, and a lubricating coating.

### BACKGROUND OF THE INVENTION

1. Field of the Invention

The present invention relates to fluid-dynamic-pressure employing bearings (i.e., fluid dynamic bearing units) and spindle motors including the fluid dynamic bearing units, and storage disk drives including the spindle motors.

2. Description of the Related Art

Conventionally, ball bearings and roller bearings are adapted for motors used in storage disk drives to spin data storage disks. Recently, fluid dynamic bearing units are increasingly adapted to the motors in order to meet demands of reducing the size, the vibration, the noise of motors.

The fluid dynamic bearing unit is defined with a bearing member and a shaft loosely fitted in the bearing member in a manner rotatable relative to the bearing member. The fluid dynamic bearing unit generally includes a thrust bearing portion and a radial bearing portion. The thrust bearing portion supports the load of the shaft or the bearing member in an axial direction. The radial bearing portion supports the load of the shaft or the bearing member in a radial direction. The thrust bearing portion and the radial bearing portion are respectively defined with portions of surfaces of bearing and the shaft opposing to each other via a gap defined therebetween. In addition, at least one of the surfaces of the bearing member and the shaft includes a dynamic-pressure-generating-groove array and the gap is filled with a lubricating fluid.

For example, when the shaft turns about the rotational axis, the lubricating oil filling the gap flows along the dynamic-pressure-generating-groove array, and pressure in the lubricating oil is locally increased. With the pressure induced in the lubricating oil at the thrust bearing portion and the radial bearing portion, the loads in the axial direction and the radial direction are supported respectively.

When the motor turns in the high speed, the temperature in the lubricating oil increases, and the increased temperature degrades the lubricating oil. As a result, the motor may fail due to the seizure or scratched of the surfaces of the bearing member and the shaft.

In order to prevent the seizure or the scratched, the lubricating oil including fatty acid triester of torimetirorlpropan used as a base oil and hindered phenol antioxidant and benzotriazole used as additives may be used for the fluid dynamic bearing unit.

In addition, the lubricating oil used for the spindle motor may include predetermined amount of the antistatic additive and the antioxidant.

### SUMMARY OF THE INVENTION

Preferred embodiments of the present invention provide a fluid dynamic bearing unit in which at least one of a shaft and a bearing of a fluid dynamic bearing unit includes on a surface thereof an additive-providing member having an additive which maintains and/or improves a performance of the lubricating oil. A lubricating oil may include a base oil and the additive, and be disposed between the shaft and the bearing and contact the additive-providing portion. Through the configuration, the additive included in the additive-providing member is slowly dissolved into the lubricating oil in the prolonged period, preventing the seizure of the fluid dynamic bearing unit for a prolonged period.

The preferred embodiments of the present invention also provide a spindle motor using the fluid dynamic bearing unit and a storage disk drive using the spindle motor.

### BRIEF DESCRIPTION OF THE DRAWINGS

FIG. 1 is a cross sectional view illustrating a storage disk drive according to a first preferred embodiment of the present invention.

FIG. 2 is a cross sectional view illustrating a spindle motor according to the first preferred embodiment of the present invention.

FIG. 3 is a view illustrating a principle portion of the spindle motor illustrated in FIG. 2 in a magnified manner.

FIG. 4 is a cross sectional view illustrating a spindle motor according to a second preferred embodiment of the present invention.

### DETAILED DESCRIPTION OF THE PREFERRED EMBODIMENTS

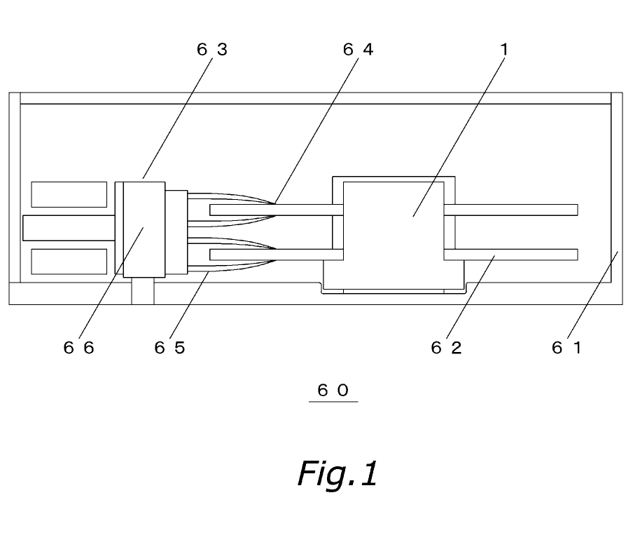

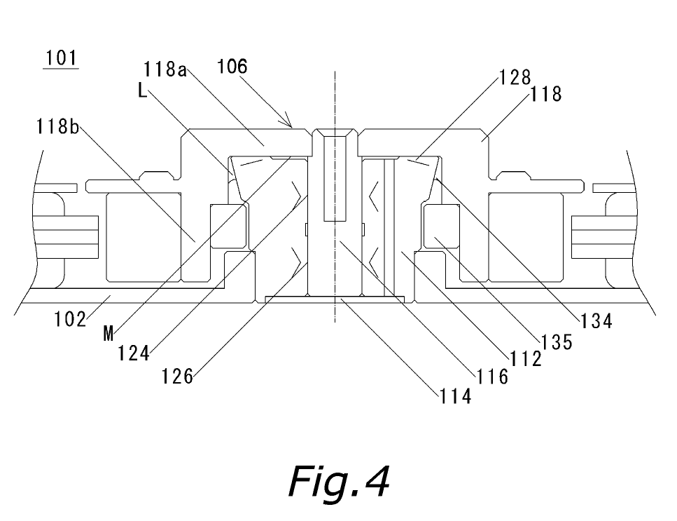

With reference to FIGS. 1 through 4, a spindle motor and a storage disk drive according to preferred embodiments of the present invention will be described in detail.

### First Preferred Embodiment

### (Configuration of Storage Disk Drive)

FIG. 1 is a drawing illustrating an internal configuration of a storage disk drive device 60 (e.g., a hard disk drive) according to a first preferred embodiment of the present invention. The interior space of a casing 61 of the disk drive 60 is a clean space where dusts and debris are extremely slight. In the casing 61, there is provided a spindle motor 1 (hereinafter referred to as a motor 1), a storage disk 62 arranged on the motor 1, and an access unit 63 reading information from and/or writing information onto the storage disk 62.

The access unit 63 includes heads 64 that adjoin the storage disk 62 for magnetically writing information from and/or reading information onto the storage disk 62, arms 65 that support the heads 64, and a head-shifting mechanism 66 that by shifting the arms 65 varies the position of the heads 64 relative to the storage disk 62. Through the configuration of these components, the heads 64 access required positions on the spinning storage disk 62 when the heads 64 have been brought adjacent to the storage disk 62 to conduct the reading and/or writing of information from/onto the storage disk 62.

### (Configuration of Spindle Motor)

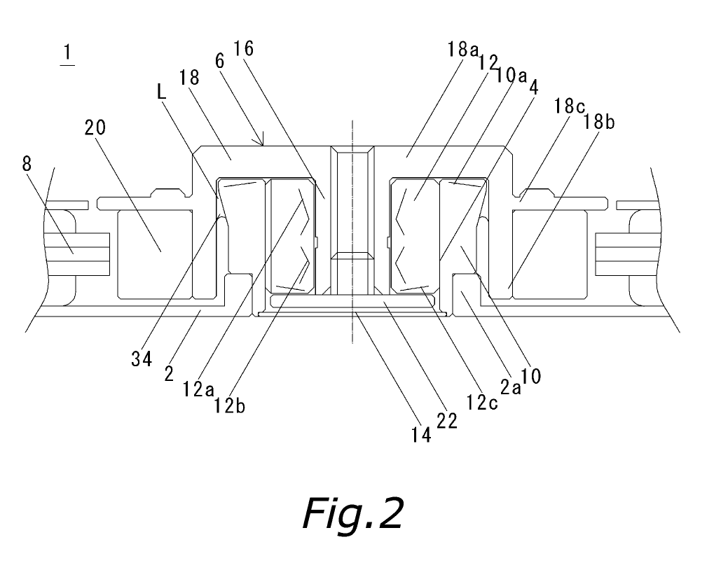

The motor 1 according to the present preferred embodiment of the present invention includes, as illustrated in FIG. 2: a base plate 2; a bearing housing 10 arranged on the base plate 2; a sleeve 12 arranged on a radially inside of the bearing housing 10; and a rotor 6 supported by means of the sleeve 12 in a rotatable manner.

An annular protrude 2a defining a center hole radially inside thereof, in which the bearing housing 10 is fitted, is provided to the base plate 2, and a stator 8 is arranged on the base plate 2 in a radially outward of the annular protrude 2a. The bearing housing 10 is fixed along the inner circumference of the annular protrude 2a by pressure-fitting and/or adhesive joining.

The bearing housing 10 has a hollow-substantially-cylindrical shape and a planar counterplate 14 is attached to the bearing housing 10 to close off the axially lower side of the bearing housing 10. The bearing housing 10 is preferably made of stainless steel or resin. The sleeve 12 having a hollow substantially cylindrical shape is fixed along an inner circumferential surface of the bearing housing 10. An outer circumferential surface of the sleeve 12 is fixed to the inner circumferential surface of the sleeve 12 with a joining agent 4 (e.g., an adhesive layer arranged therebetween). An inner circumferential surface of the sleeve 12 defined a through hole penetrating the sleeve 12 along the center axis. The sleeve 12 is made of porous material (e.g., a sintered metal material) and is impregnated with a lubricating oil L. The porous material may be obtained by, but not limited to, pressing and sintering a powdered material (e.g., a powdered metal, non-metal powdered material, and the like)

The rotor 6, which is the rotary unit of the motor 1, includes a shaft 16 having an outer circumferential surface radially opposing the sleeve 12 via a gap defined therebetween, and the rotor hub 18, which has a substantially cup-shape and is integral with the shaft 16.

The rotor hub 18 includes: a top-wall portion 18a which axially opposes a top end surfaces of the bearing housing 10 and the sleeve 12; a cylindrical wall portion 185b which axially extends from the radially outer end of the top-wall portion 18a; and a flange portion 18c extending radially outward from an outer cylindrical surface of the cylindrical wall portion 18b. The storage disk 62 (see FIG. 1) is to be arranged on the flange portion 18c. A radially inner portion of the storage disk 62 comes in contact with the outer circumferential surface of the cylindrical wall portion 18b and an axially upper portion of the flange portion 18c. At an axially lower side of the flange portion 18c, a rotor magnet is fixed along the outer circumferential surface of the cylindrical wall portion 18b with an adhesive.

The rotor 6 further includes a thrust plate 22, being a circular component, fixed to the axially lower end of the shaft 16. Each of the top and bottom surfaces of the thrust plate 22 respectively opposes via an axial gap the bottom-end surface of the sleeve 12 and the top surface of the counter plate 14, while the circumferential surface of the thrust plate 22 opposes via a radial gap the inner circumferential surface of the bearing housing 10.

In the configuration as described above, the gap between the underside of the top wall portion 18a of the rotor hub 18 and the top end surface of the bearing housing 10, the gap between the underside of the top wall portion 18a of the rotor hub 18 and the top end surface of the sleeve 12, the gap between the inner circumferential surface of the sleeve 12 and the outer circumferential surface of the shaft 16, the gap between the bottom end surface of the sleeve 12 and the top side surface of the thrust plate 22, and the gap between the top surface of the counterplate 14 and the bottom side surface of the thrust plate 22, are continuous. With the lubricating oil L thus being retained without interruption in the continuous gaps, a full-fill structure is defined.

The upper portion of the outer circumferential surface of the bearing housing 10 is slanted such that an outer diameter of the bearing housing 10 is reduced heading axially downward (i.e., toward the base plate 2) from the top end surface of the bearing housing 10. The upper portion of the outer circumferential surface of the bearing holder 10 radially opposes the cylindrical wall portion 18b via a gap defined therebetween. The clearance dimension defined by the gap between the upper portion of the outer circumferential surface of the bearing housing 10, and the cylindrical wall portion 18b grows gradually larger as parting away from the top-wall portion 18a, heading axially downward. In effect, the upper portion of the outer circumferential surface of the bearing housing 10 and the cylindrical wall portion 18b define a capillary seal portion 34. Only in this capillary seal portion 34, the lubricating oil L retained in the gaps described above meet the air in an interface where the surface tension of the oil and atmospheric pressure balance, forming the oil-air interface into a meniscus.

### (Configuration of Bearing)

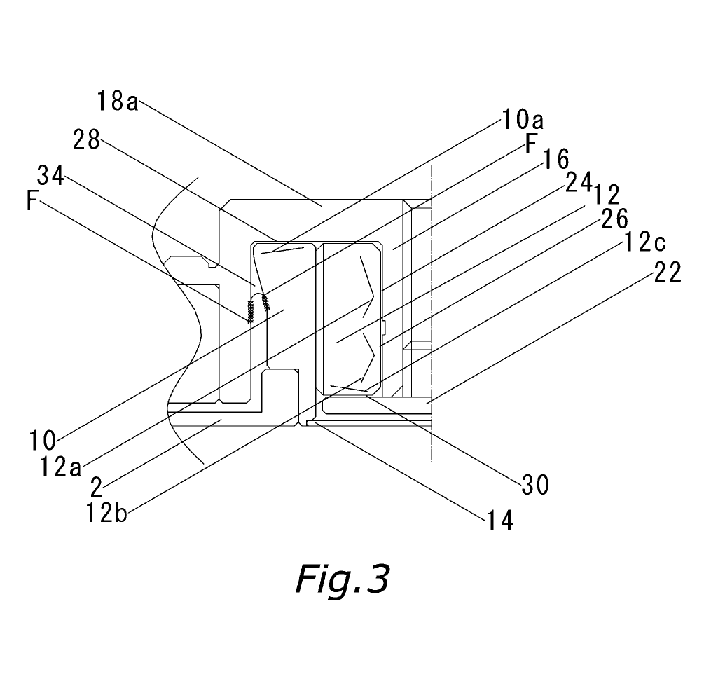

Next, referring to FIG. 3, a configuration of the fluid dynamic bearing unit of the motor 1 will be described in detail.

As illustrated in FIG. 3, an upper radial bearing section 24 and a lower radial bearing section 26, axially separated to each other, are provided in the radial gap defined between the inner circumferential surface of the sleeve 12 and the outer cylindrical surface of the shaft 16. The upper radial bearing section 24 and lower radial bearing section 26 are defined by the inner circumferential surface of the sleeve 12, the outer circumferential surface of the shaft 16, and the lubricating oil L retained in the gap where the sleeve 12 and the shaft 16 radially oppose each other.

In the position where the upper radial bearing section 24 along the inner circumferential surface of the sleeve 12 is defined, hydrodynamic pressure generating grooves arrayed in the herringbone shape (hereinafter referred to as a herringbone groove array 12a) having an imbalanced geometry axis-wise is arranged. When the rotor 6 rotates, a pressure heading from both axis-wise ends of the upper radial bearing section 24 toward the approximate midportion is induced in the lubricating oil L at the upper radial bearing section 24 by the herringbone groove array 12a. In the present preferred embodiment of the present invention, the herringbone groove array 12a has the imbalanced geometry axis-wise (e.g., the grooves arranged axially upperside have greater axial length than these arranged axially lowerside). Due to the configuration, the pressure directed from the axially upper end toward the approximately midportion of the upper radial bearing section 24 becomes greater than its counterpart, flowing the lubricating oil L toward axially lower direction.

In the position where the lower radial bearing section 26 along the inner circumferential surface of the sleeve 12 is defined, a herringbone groove array 12b having an approximately balanced geometry axis-wise is arranged. When the rotor 6 rotates, a pressure heading from either axis-wise edge toward the approximate midportion of the lower radial bearing section 26 is induced in the lubricating oil L at the lower radial bearing section 26 by the herringbone groove array 12b.

The top end surface of the bearing housing 10 and the underside of the top wall portion 18a of the rotor hub 18 oppose each other via an upper axial gap defined therebetween. The upper axial gap is filled with the lubricating oil L and an upper thrust bearing section 28 is provided in the upper axial gap.

There is provided a dynamic pressure generating grooves arrayed in a spiral shape (hereinafter referred to as a spiral groove array 10a) in the top end surface of the bearing housing 10. When the rotor 6 rotates, a pressure directed radially inward is induced in the lubricating oil L at the upper thrust bearing section 28 by the spiral groove array 10a. Through the configuration, while the pressure in the upper thrust bearing section 28 is increased, the rotor 6 is lifted in the axial direction. In addition, the pressure in the lubricating oil L thus being always kept high with respect to the external air prevents the turning into bubbles of air that has dissolved into the oil.

Likewise, a lower thrust bearing section 30 is defined in the axial gap between the bottom end surface of the sleeve 12 and the top surface of the thrust plate 22. There is provided a dynamic pressure generating grooves arrayed in a spiral shape (hereinafter referred to as a spiral groove array 12c) in the bottom end surface of the sleeve 12. When the rotor 6 rotates, a pressure directed radially inward is induced in the lubricating oil L at the upper thrust bearing section 28 by the spiral groove array 10a.

Accordingly, the upward-lifting action on the rotor 6 by the upper thrust bearing section 28 and the downward-thrusting action on the thrust plate 22 by the lower thrust bearing section 30 pressure the rotor 6 up and down. In the location where these pressure forces balance, the position where rotor 6 is lifted is stabilized. The upper and lower thrust bearing sections 28 and 30 are configured so that the axial pressure forces generated in these thrust bearing sections 28 and 30 operate interactively from mutually opposing directions, thereby to stably support the rotation of the rotor hub 18.

When the sleeve 12 made of the sintered material is press-molded, the herringbone groove arrays 12a and 12b provided in the upper and lower radial bearing section 24 and 26, and the spiral groove array 12c provided in the lower thrust bearing section 30 can be formed. In this way the sleeve 12 can be manufactured in a less expensive manner.

In the present preferred embodiment of the present invention, an oil repellent finish is applied to portions, near the oil-air interface, of the bearing housing 10 and the rotor hub 18 to prevent the lubricating oil leakage. More specifically, as illustrated in FIG. 3, an oil-repellent coating is arranged axially below the oil-air interface at the upper portion of the outer circumferential surface of the bearing housing 10 where an outer diameter of the bearing housing 10 is reduced heading axially downward. In addition, another oil-repellent coating is arranged axially below the oil-air interface at a portion of the inner circumferential surface of the cylindrical wall portion 18b where is radially facing the upper portion of the outer circumferential surface of the bearing housing 10. The oil-repellent coating may be provided by applying oil-repellent agent to the predetermined portion of the motor 1. With the oil-repellent coatings F, the lubricating oil L does not run along the outer circumferential surface of the bearing housing 10 and/or the inner circumferential surface of the cylindrical wall portion 18d of the rotor holder 6, preventing the lubricating oil L from leaking outside of the fluid dynamic bearing unit.

### (Composition of Lubricating Oil)

The description about the lubricating oil L used in the present preferred embodiment of the present invention will be made below. The lubricating oil L includes a base oil and an additive(s) that maintains or improves the characteristics of the base oil and the base oil. The base oil may be mineral oil, synthetic oil or a combination thereof. Meanwhile, any preferable mineral oil or synthetic oil may be used as the base oil in the present preferred embodiment of the present invention. It is preferable that the kinetic viscosity at 40 degree Celsius of the lubricating oil L is about 3 to about 500 mm²/S.

When the kinetic viscosity at 40 degree Celsius of the lubricating oil L is less than about 3 mm²/S, an appropriate oil coating may not be provided. When the kinetic viscosity at 40 degree Celsius of the lubricating oil L is greater than about 500 mm²/S, resistant torque of the rotation of the shaft 16 increases, resulting in degrading the performance of the fluid dynamic bearing unit.

Paraffinic mineral oil, naphthenic mineral oil, combination thereof, and the like may be used as the base oil according to the present preferred embodiment of the present invention. These base oils may be obtained by the refinements of the solvent refining, the hydrofining and the like.

A preferable synthetic oil may be selected one or more from a group including hydrocarbon synthetic oil, ether oil (e.g., monoester, diester, polyol ester (such as trimethylolpropane, pentaerythritol, dipentaerythritol, neopentyl diol ester, and complex ester), polyglycol ester, glyceroester, aromatic ester, alkylation diphenyl ether, alkylation triphenyl ether, alkylation tetraphenyl ether, and alkylation polyphenyl ether), silicone oil, fluorine oil, combination thereof, and the like.

Preferably, for use in the fluid dynamic bearing unit, the hydrocarbon synthetic oil such as poly a olefin and ester oil may be used as the base oil of the lubricating oil L. More preferably, ester oil may be used as the base oil of the lubricating oil L.

The mineral oil and the synthetic oil may be mixed and the mixture may be used as the base oil of the lubricating oil L. Any preferable techniques well known in the art may be adapted to mix two or more of above listed oils.

The lubricating oil L may include an additive(s) (e.g., anti-oxidant and the like). Any suitable antioxidants (e.g., a phenolic antioxidant, an amine antioxidant, a metallic antioxidant, combination thereof, and the like conventionally used for the lubricating oil of the fluid dynamic bearing unit) may be added to the base oil to obtain the lubricating oil L according to the present preferred embodiment of the present invention.

The antioxidant may be preferably added to the base oil such that the lubricating oil L contains about 5 percent by weight or less antioxidant. More preferably, the lubricating oil L contains about 3 percent by weight or less, further preferably, it contains about 1 percent by weight or less antioxidant. Even the antioxidant is added to the base oil in the amount exceeding about 5 percent by weight, the protection against oxidation will not be proportional to the loadings of the antioxidant. In addition, to obtain preferable protection against oxidation, about 0.1 percent by weight or more antioxidant is added to the base oil.

Moreover, the additive(s) other than the antioxidant (e.g., an anti-wear agent, a metal deactivator, a corrosion inhibitor, an electroconductive agent, and the like) can be added to the base oil.

The anti-ware agent may be selected one or more from the group including phosphate ester, dialkyl dithio zinc phosphate, and the like. Benzotriazole, imidazoline, pyrimidine, derivative thereof, and the like compounds (generally having the Nitrogen-Carbon-Nitrogen binding) are well known in the art as the metal deactivator, which may be added to the base oil. The metal deactivator inhibits oxidation of the lubricating oil L by chelating metal ions that catalyze oxidation, or by forming an inert coating around metal members. The corrosion inhibitor may be selected one or more from the group including benzotriazole and benzotriazole compounds. The electroconductive agent may be selected one or more from the group including the organometallic compounds such as sulfonate, fenat, and sarishirat, organic compounds such as succinate derivative and amine derivative (e.g., succinate imide, succinate ester, and the poly butenyl amine), carbon black and electroconductive polymer polymer.

### (Configuration of Bearing Member)

At least a portion of the members defining the fluid dynamic bearing unit as described above includes the additive(s) being present in the lubricating oil L. The additive(s) being included in portion of the members is in contact with the lubricating oil L at a surface of the member. In the present preferred embodiment of the present invention, the member may be selected one or more from the group including the joint agent 4 (e.g., the adhesive), the bearing housing 10 made of resin, the sleeve 12 made of the sintered material, and the oil-repellent coatings F made of an oil-repellent agent. The joint agent 4 may be selected one or more from any suitable adhesives such as anaerobic adhesives, epoxy adhesives (normal temperature curable adhesives and elevated temperature curable adhesive), UV curable adhesives, acrylic adhesives, rubber adhesives, combination thereof, and the like, to which the additive(s) present in the lubricating oil L is added. The bearing housing 10 may be formed by injection molding using resin selected one or more from the group including nylon resin, PPS (polyphenylene sulfide), LCP (liquid crystalline polymer resin) and rmoplastic resin (e.g., engineering plastic), combination thereof, and the like, to which the additive(s) present in the lubricating oil L is added. The sleeve 12 is made of porous material obtained by pressing and sintering the powdered metal (e.g., a powdered metal, non-metal powdered material, ceramic, synthetic resin, combination thereof, and the like) to which the additive(s) present in the lubricating oil L is added. The sleeve 12 may be obtained by foam molding with the resin to which the additive(s) present in the lubricating oil L is added. The oil repellent agent may be selected from one or more from the group including fluorocarbon polymer such as polytetrafluoroethylene (PTFE), poly vinylidene fluoride (PVDF), poly vinyl fluoride (PVF), ethylene tetrafluoroethylene copolymers (ETFE), ethylene chloro trifluoroethylene copolymers (ECTFE), and the like. Specifically, perfluoro resin having a preferable oil-repelling characteristic and low surface energy is preferably used in the present preferred embodiment of the present invention. The additive(s) present in the lubricating oil F may be added to the oil repellent agent. The additive(s) may be dispersed in the joint agent 4 (e.g., the adhesive), and then, may be applied to the sleeve 12 and the bearing housing 10 to join them, for example. The additive(s) may be dispersed in the resin which is used for injection molding of the bearing housing 10. The additive(s) may be dispersed in the oil-repellent which is used for forming the oil repellent layer F. The additive(s) may be mixed with the powder material which is used for forming the sleeve 12. Other preferable techniques known in the art may be adapted to mix the additive(s) to the members defining the fluid dynamic bearing unit of the motor 1.

By defining the fluid dynamic bearing unit with the member in which the additive(s) is added, the additive(s) in the member slowly dissolves into the lubricating oil L in a prolonged period. Thus, even if the additives added in the lubricating oil L in the beginning is deteriorated due to the aged deterioration thereof for example, the additional additive(s) is provided to the lubricating oil F from the surface of the member defining the fluid dynamic bearing unit in contact with the lubricating oil L. Through the configuration, the preferable bearing property can be maintained for a prolonged period.

It is preferable that the amount of additive(s) added to the member is greater than that added to the lubricating oil L in the beginning. The effective concentration of the additive(s) to produce the effect(s) thereof is predetermined, and thus, in order to maintain the preferable effect of the additive(s) in the prolonged period, the additive(s) may be included in the member as much as possible. In the present preferred embodiment of the present invention, the total amount of the additive(s) to be included in the member(s) defining the fluid dynamic bearing unit is about twice or greater than that to be added in the lubricating oil L in the beginning. Through the configuration, the additive(s) in the member(s) can dissolve into the lubricating oil L in a prolonged period.

The joining agent 4 may defined by two or more kinds of adhesives (e.g., the anaerobic adhesive and UV curable adhesive), and one of them to contact with the lubricating oil L may include additive(s) included therein. All of the joining agent 4, the bearing housing 10, and the sleeve 10, may include the additive(s), or some of them (e.g., one or two of them) may include the additive(s).

Alternatively, the bearing housing 10 and/or sleeve 12 may includes a concave portion and/or a groove which is filled with the adhesive with the additive(s). Through the configuration described above, the additive(s) is provided to the lubricating oil L in the prolonged period.

### Second Preferred Embodiment

### (Configuration of Spindle Motor)

FIG. 2 is a cross sectional view illustrating a spindle motor according to a second preferred embodiment of the present invention. Here, inasmuch as the basic configuration of the motor according to the second preferred embodiment of the present invention is substantially equivalent to that described in the description of the first preferred embodiment of the present invention, correspondences are denoted with reference marks for the corresponding components being in the 100s, and detailed description will be made mainly of the portions that are different.

In a motor 101, gaps are provided between an undersurface of a top wall portion 118a of the rotor hub 118 and the top end surface of the sleeve 112, between an inner circumferential surface of an sleeve 112 and an outer circumferential surface of an shaft 116, and between the lower end surface of the shaft 116 and a top surface of a counter plate 114, whereby the gaps are all continuous. The lubricating oil L is retained without interruption in the continuous gaps, and a full-fill structure is defined.

There is provided an upper portion of the outer circumferential surface of the sleeve 112 where is slanted such that an outer diameter thereof is reduced heading axially downward. The clearance dimension defined by the gap between the upper portion of the outer circumferential surface of the sleeve 112, and the cylindrical wall portion 118b of the sleeve 112 grows gradually larger as heading axially downward. In effect, the upper portion of the outer circumferential surface of the sleeve 112 and the rotor hub 118 define a capillary seal portion 134.

Only in this capillary seal portion 134, the lubricating oil L retained in the gaps described above meets the air-in an interface where the surface tension of the oil and atmospheric pressure balance, forming the oil-air interface into a meniscus.

A ring-shape retaining member 135 is attached to the rotor hub 118 at axially below (i.e., a base plate 102 side) the capillary seal portion 134. The retaining member 135 is fixed to the axially lower portion of the cylindrical wall portion 118b with adhesives and is arranged axially below the portion of the outer circumferential surface of the sleeve 112 where is slanted heading axially downward. A radially inner end of the retaining member 135 is arranged radially inside of the portion of the outer circumferential surface of the sleeve 112 where is slanted, such that the retaining member 135 engages with the sleeve 112 when the force directed axially upward is applied to a rotor 106, preventing the rotor 106 from being removed. With the configuration, the movement of the rotor 106 relative to the sleeve 112 in the axial direction is restricted.

An inner circumferential surface of the retaining member 135 opposes to the outer circumferential surface of the sleeve 112 via a minute gap defined therebetween. The gap is continuous to the capillary seal portion 134 and the clearance dimension of the minute gap is smaller than the minimum gap clearance of the capillary seal portion 134.

By configuring the clearance dimension of the minute gap as small as possible, a labyrinth seal portion is defined. When the motor rotates, air disposed in the labyrinth seal portion rotates in a higher speed than that air disposed in the capillary seal portion 134, trapping the vapor of the lubricating oil L in the capillary seal portion 134. As a result, the pressure in the capillary seal portion 134 is increased, and thus the vapor pressure of the lubricating oil L is increased, preventing the lubricating oil L from evaporating.

### (Configuration of Bearing)

An upper radial bearing section 124 and a lower radial bearing section 126, axially separated from each other, are arranged in the radial gap defined between the inner circumferential surface of the sleeve 112 and the outer cylindrical surface of the shaft 116. The upper radial bearing section 124 and lower radial bearing section 126 are defined by the inner circumferential surface of the sleeve 112, the outer circumferential surface of the shaft 116, and the lubricating oil L retained in the gap where the sleeve 112 and the shaft 116 radially oppose to each other.

Turning now to the motor's axially directed bearing configuration, in a micro-gap across which the top-edge face of the sleeve 112, and the undersurface of the top-wall portion 118a of the rotor hub 118 axially oppose to each other, a thrust dynamic-pressure bearing 124 is provided.

A lubricating coating M made of solid lubricating substance is arranged at a portion of a lower surface of the top wall portion 118a where axially opposes to the top end wall of the sleeve 112.

### (Configuration of Bearing Member)

The lubricating coating M may include the additive(s) present in the lubricating oil L. The lubricating coating M is made of a solid lubricant and thermosetting resin. The solid lubricant may be selected one or more from the group including molybdenum sulfide, sulfuretted tungsten, graphite, boron nitride, antimony trioxide, poly tetra fluorinated ethylene (PTFE), mica isinglass, talc, soapstone, zinc flower, and the like. Preferably, molybdenum sulfide may be used for the solid lubricant, and more preferably, molybdenum disulfide may be used for the solid lubricant in the preferred embodiment of the present invention. Any suitable thermosetting resin having heat resistance may be used for the lubricating coating M. The thermosetting resin may be selected one or more from the group including polyamide-imide resin, epoxy resin, alkyd resin, phenol resin, and polyimide resin. Preferably polyimide resin is used for the solid lubricant in the preferred embodiment of the present invention. The additive(s) present in the lubricating oil L may be added to the thermosetting resin and/or the solid lubricant. The additive(s) may be mixed to the thermosetting resin and/or the solid lubricant by any preferable techniques known in the art.

By defining the bearing with the member in which the additive(s) are added, the additive(s) in the member slowly dissolves into the lubricating oil L in a prolonged period. Thus, even if the additive(s) added in the lubricating oil L in the beginning is deteriorated, the additional additive(s) will be provided to the lubricating oil L from the surface of the member defining the fluid dynamic bearing unit in contact with the lubricating oil L. Through the configuration, the preferable bearing property can be maintained in a prolonged period.

### EXAMPLES

Next, the description of the lubricating oil according to the preferred embodiment of the present invention will be made below. In the examples of the present preferred embodiment of the present invention, the diester oil is used as the base oil of the lubricating oil.

### Example 1

Following adhesive is used in the preferred embodiment of the present invention.
Adhesive: Two-part thermosetting adhesive (made of base resin and curing agent 10% by weight of base resin) mixed with the antioxidant (4,4′-dibutyl diphenylamine) 5% by weight of the two-part thermosetting adhesive (hereinafter simply referred to as the adhesive).

The adhesive is cured under the following condition.
Curing Condition: 90 degree Celsius for 3 hours

The cured adhesive block is immersed in the base oil, and stored for 4 days at 150 degree Celsius.

Then, the cured adhesive block is removed from the base oil, and the degradation of the base oil is inspected with a high performance liquid chromatography [GPC column: (stationary phase: Styrene divinyl benzene polymer, mobile phase: tetrahydrofuran) detector: differential refractometer (RI)]. The degree of degradation may be determined by calculating an area of the peak corresponding to the base oil. A result is illustrated in Table 1.

### Comparative Example

The base oil is stored for 4 days at 150 degree Celsius without the cured adhesive block immersed therein, and then, the base oil is inspected with the high performance liquid chromatography. A result is illustrated in Table 1.

TABLE 1

| | Base | Deterioration | Deterioration | Antioxidant |
|---|---|---|---|---|
| | Oil (%) | Product 1 (%) | Product 2 (%) | (%) |
| Example 1 | 98.84 | 0.68 | 0.47 | ND |
| Comparative | 60.33 | 22.5. | 17.15 | 0 |
| Example | | | | |

As illustrated in Table 1, in the Example 1, formation of the deterioration products derived from the base oil is inhibited even under high-temperature condition. Thus, in the Example 1, the additive(s) added in the adhesive is dissolve into the base oil and inhibits the degradation of the base oil.

As described above, by mixing the additive(s), being present in the lubricating oil (e.g. , the antioxidant, the anti-wear agent, the metal deactivator, the corrosion inhibitor, and the electroconductive agent), into the member(s) defining the bearing contacting with the lubricating oil (e.g., the joining member such as the adhesive, the bearing housing made of resin, the sleeve made of porous material, the lubricating coating made of the solid lubricant, and the oil repellent coating), the additive(s) slowly dissolves into the lubricating oil L in a prolonged period and thus the degradation of the lubricating oil is inhibited for a prolonged period. Therefore, the bearing property is preferably maintained for a prolonged period, making the motor adapting the fluid dynamic bearing unit and the storage disk drive adapting the motor have prolonged product lives.

Although in the foregoing descriptions have been made of preferred embodiments of the present invention of a spindle motor, and a storage disk drive including the spindle motor, the present invention is not limited to the given preferred embodiments; various alterations and modifications are possible without departing from the scope and the spirit of the present invention.

In the preferred embodiment of the present invention, the fluid dynamic bearing unit according to the preferred embodiment of the present invention includes two radial bearing portions and one or two thrust bearings. It should be noted that the configuration of the fluid dynamic bearing unit is not limited to that described above. The shapes of the grooves, the positions to which the bearing portions are arranged, the number of the bearing portions and the like may be variously modified.

What is claimed is:

1. A fluid dynamic bearing unit comprising:
a shaft;
a bearing rotatable relative to the shaft;
an additive-providing portion including on a surface thereof an additive and arranged on at least one of the shaft and the bearing; and
a lubricating oil including a base oil and the additive, disposed between the shaft and the bearing, and contacting the additive-providing portion.

2. The fluid dynamic bearing unit as set forth in claim 1, wherein the additive-providing portion is defined by an adhesive which includes the additive.

3. The fluid dynamic bearing unit as set forth in claim 2, wherein the at least one of the shaft and the bearing is defined with two or more components joined by the adhesive.

4. The fluid dynamic bearing unit as set forth in claim 1, wherein:
the at least one of the shaft and the bearing includes a coating which covers a portion of the at least one of the shaft and the bearing and contacts the lubricating oil, and
the additive-providing portion is defined by the coating in which the additive is included.

5. The fluid dynamic bearing unit as set forth in claim 4, wherein the coating includes a solid lubricant.

6. The fluid dynamic bearing unit as set forth in claim 5, wherein the coating is an oil repellent coating.

7. The fluid dynamic bearing unit as set forth in claim 1, wherein a portion of the at least one of the shaft and the bearing is formed by injection molding using resin in which the additive is included.

8. The fluid dynamic bearing unit as set forth in claim 7, wherein the bearing includes a sleeve and a housing having an inner circumferential surface attached to an outer circumferential surface of the sleeve, the housing is formed by injection molding using the resin in which the additive is included.

9. The fluid dynamic bearing unit as set forth in claim 1, wherein an amount of the additive included in the lubricating oil is about half or less of a total amount of the additive included in the fluid dynamic bearing unit.

10. A spindle motor comprising:
a fluid dynamic bearing unit as set forth in claim 1;
a rotor magnet rotatable in accordance with a rotation of the shaft or the bearing;
a stator facing the rotor magnet.

11. A storage disk drive comprising:
a base plate;
the spindle motor as set forth in claim 10 arranged on the base plate:
a data storage disk on which information is stored, the data storage disk is arranged on and is rotated by the spindle motor;
an access unit reading the information from and/or writing the information onto the storage disk.

12. A fluid dynamic bearing unit comprising:
a shaft;
a bearing rotatable relative to the shaft;
a lubricating oil including a base oil and an additive, and disposed between the shaft and the bearing; and
a concave portion arranged on a surface of at least one of the shaft and the bearing,
wherein the additive is arranged in the concave portion, and the lubricating oil contacts with the additive arranged in the concave portion.

13. The fluid dynamic bearing unit as set forth in claim 12, wherein the concave portion is filled with an adhesive which includes the additive.

14. The fluid dynamic bearing unit as set forth in claim 12, wherein an amount of the additive included in the lubricating oil is about half or less of a total amount of the additive included in the fluid dynamic bearing unit.

15. A spindle motor comprising:
a fluid dynamic bearing unit as set forth in claim 12;
a rotor magnet rotatable in accordance with a rotation of the shaft or the bearing; and
a stator facing the rotor magnet.

16. A storage disk drive comprising:
a base plate;
the spindle motor as set forth in claim 15 arranged on the base plate:
a data storage disk on which information is stored, the data storage disk is arranged on and is rotated by the spindle motor; and
an access unit reading the information from and/or writing the information onto the storage disk.

17. A fluid dynamic bearing unit comprising:
a shaft;
a bearing rotatable relative to the shaft; and
a lubricating oil including a base oil and an additive, and disposed between the shaft and the bearing,
wherein
a portion of at least one of the shaft and the bearing is made of porous material which includes the additive, and
the lubricating oil contacts with the additive included in the porous material at the portion of the at least one of the shaft and the bearing.

18. The fluid dynamic bearing unit as set forth in claim 17, wherein another portion of the at least one of the shaft and the bearing is formed by injection molding using resin which includes the additive.

19. The fluid dynamic bearing unit as set forth in claim 18, wherein the bearing includes a sleeve and a housing having an inner circumferential surface attached to an outer circumferential surface of the sleeve, the housing is formed by injection molding using the resin in which the additive is included.

20. The fluid dynamic bearing unit as set forth in claim 17, wherein an amount of the additive included in the lubricating oil is about half or less of a total amount of the additive included in the fluid dynamic bearing unit.

21. A spindle motor comprising:
a fluid dynamic bearing unit as set forth in claim 17;
a rotor magnet rotatable in accordance with a rotation of the shaft or the bearing; and
a stator facing the rotor magnet.

22. A storage disk drive comprising:
a base plate;
the spindle motor as set forth in claim 21 arranged on the base plate:
a data storage disk on which information is stored, the data storage disk is arranged on and is rotated by the spindle motor; and
an access unit reading the information from and/or writing the information onto the storage disk.
